(19) United States
(12) Patent Application Publication
(10) Pub. No.: US 2007/0233596 A1
(43) Pub. Date: Oct. 4, 2007

(54) Method and apparatus for administering a dual account loan system

(76) Inventor: Stephen Ambrose JR., Stamford, CT (US)

Correspondence Address: BUCKLEY, MASCHOFF & TALWALKAR LLC, 50 LOCUST AVENUE, NEW CANAAN, CT, 06840, US

(21) Appl. No.: 11/640,733

(22) Filed: Dec. 18, 2006

Related U.S. Application Data
(60) Provisional application No. 60/751,141, filed on Dec. 16, 2005.

(51) Int. Cl. G06Q 40/00

(52) U.S. Cl. 705/38

(57) ABSTRACT

A system, method, apparatus, means and computer program code for administering a dual account loan system is provided which includes identifying a deposit account to receive an expected refund amount from a taxing authority, establishing a loan account and disbursing loan proceeds to a taxpayer, monitoring the deposit account to identify a trigger event, and transferring funds from the deposit account to the loan account upon occurrence of the trigger event.

### CROSS-REFERENCE TO RELATED APPLICATION

This present application claims the benefit of and priority to U.S. Provisional Application No. 60/751,141 entitled “Dual Account Tax Refund Anticipation Loan System” and filed Dec. 16, 2005, the content of which are incorporated herein by reference in their entirety for all purposes.

### FIELD OF THE INVENTION

The present invention relates to credit systems. In particular, embodiments of the present invention relate to methods, apparatus, means, and computer program code for administering a dual account loan system.

### BACKGROUND

Refund anticipation loans (“RALs”) are financial transactions commonly used by taxpayers to obtain access to their expected tax refund more quickly. In general, a RAL is a short-term bank loan that is based on, and secured by, the amount of a taxpayer's anticipated tax refund. These loans are often processed at tax preparer locations.

Two general types of RALs are in common use—“classic” RALs and “instant RALs”. In a classic RAL, taxpayers receive their funds within 1 to 2 days after the taxing authority has accepted the filing of the tax return. Funds can be delivered to the taxpayer via a check or via a deposit to the taxpayer's bank account. In an instant RAL, taxpayers may receive funds the same day as their tax return is filed. Funds can be delivered to the taxpayer via check or other means. The lender takes some greater risk in an instant RAL transaction (because the taxing authority has not yet accepted the filing of the tax return), the principal amount of an instant RAL is generally less than would be available in a classic RAL.

U.S. Pat. Nos. 4,890,228, 5,193,057, 5,724,523, and 5,963,921 (the “Longfield patents”) describe several versions of a RAL system. Unfortunately, each of the Longfield patents requires that a taxpayer establish a “deposit/loan” account at a financial institution. This deposit/loan account is the account from which RAL loan proceeds are disbursed and is the account into which the taxpayer's tax refund amount is deposited.

The use of such a combined account providing a single account relationship between one financial institution and a taxpayer is undesirable in that there is no ability for a financial institution to create an on-going depository relationship with customer taxpayers. For example, many RAL customers do not have existing banking relationships with a financial institution. It would be desirable to provide a RAL product in which a deposit account is established for the customer that is separate from the RAL loan account. It would further be desirable to allow the deposit account to be held at one financial institution and the loan account at a second financial institution. It would further be desirable to provide a mechanism by which the taxpayer's access to funds in the separate deposit account could be controlled to prevent the taxpayer from accessing tax refund proceeds before the loan is paid off.

### BRIEF DESCRIPTION OF THE DRAWINGS

FIG. 1 is a block diagram of a system consistent with the present invention.

FIG. 2 is a block diagram of a system consistent with the present invention.

FIG. 3 is a block diagram of a processing system consistent with the present invention.

FIG. 4 is a flow diagram illustrating one embodiment of a process administering a dual account loan system consistent with the present invention.

### DETAILED DESCRIPTION

Applicants have recognized that there is a need for a system, method, apparatus, and computer program code for administering refund loans in a manner that overcome drawbacks of existing systems. According to one embodiment of the present invention, loans are issued and administered using two accounts: a loan account and a deposit account. Embodiments allow a tax return preparer to disburse loan proceeds secured by an expected tax refund and ensure that the loan is repaid using the refund. More particularly, some embodiments allow a first financial institution to establish the deposit account and a second financial institution to disburse the loan proceeds through the loan account. In this manner, the financial institution establishing the financial account may establish an on-going relationship with the taxpayer.

Applicant has recognized that such a dual account system should include a mechanism for ensuring that the taxpayer should not have access to tax refund proceeds that are deposited in the deposit account until the loan from the loan account has been repaid. As such, as part of some embodiments of the present invention, Applicant provides a trigger event that causes funds from the deposit account to be transferred to the loan account. The trigger event may be, for example, the identification of a deposit into the deposit account from a taxing authority or it may be the funding of the loan itself. In some embodiments, the trigger event causes a credit to the deposit account in the amount of the deposit, and a debit equal to the amount of the loan, where the debited funds are transferred to pay off the loan amount. In this manner, applicant has provided a RAL system that allows a taxpayer to establish an on-going depository relationship with a financial institution where the deposit account may survive repayment of the loan. Under this system it is possible for the client to have received their loan proceeds from the lending institution while simultaneously have an un-funded deposit account open with the deposit institution. If is further possible for the deposit account to go into default while the client continues to have access to their lending institution account.

Embodiments of the present invention provide a system, method, apparatus, and computer program code for administering a dual account system. Applicant has recognized a need for a dual account loan system that allows loan proceeds to be repaid reliably, accurately, and efficiently. Pursuant to some embodiments, a transaction involving the dual account system involves the interaction of a number of entities: a taxpayer, a tax return preparer, a taxing authority (and, in some embodiments, a payment processor associated with the taxing authority), a lender, and an affiliated or unaffiliated banking entity. Pursuant to some embodiments, a number of different refund loan products may be issued and paid off using the dual account system, including, for example: a classic refund anticipation loan (“RAL”), an instant RAL (“iRAL”) and a refund anticipation check (“RAC”).

In general, a RAL is a loan disbursed to a taxpayer after the IRS has performed initial processing of a tax return and before the tax refund would otherwise have been received by the taxpayer. An iRAL is a loan that is generally less than the refund amount that is disbursed to a taxpayer before the IRS has performed initial processing of the tax return. A RAC, or refund anticipation check, is a direct deposit of the refund amount into a taxpayer account.

With these and other advantages and features of the invention that will become hereinafter apparent, the nature of the invention may be more clearly understood by reference to the following detailed description of the invention, the appended claims and to the several drawings attached herein.

A number of terms will be used herein to describe features of the present invention. For example, the term “taxing authority” is used to refer to a governmental entity with which a tax return must be filed. In an example to be carried throughout this disclosure, the taxing authority is the United States government.

The term “tax return preparer” is used to refer to an individual or entity authorized to prepare and file a tax return with a taxing authority on behalf of taxpayers.

The term “refund anticipation loan” is used to refer to a loan that is secured by a taxpayer's (the “borrower's”) expected tax refund. A RAL provides a borrower with loan proceeds within several days of filing a tax return. In some embodiments, the loan proceeds are provided once a “debt indicator” has been received from the taxing authority.

The term “instant refund anticipation loan” (or “iRAL”) is used to refer to a loan that is secured by a borrowers expected tax refund. An iRAL provides a borrower with loan proceeds almost immediately (e.g., while the borrower is at a tax preparer's office) rather than waiting several days as required for a standard RAL.

The term “debit card” is used to refer to a payment card that allows the cardholder to access funds in an account. The account may be a direct deposit account (“DDA”) or other financial account holding funds available to the cardholder. In general, debit cards include cards allowing access to funds at automated teller machines (“ATMs”) as well as cards allowing access to funds at point of sale devices (e.g., in a purchase transaction) using either PIN or signature.

These and other features will be discussed in further detail below, by first describing a system, individual devices, exemplary databases and processes according to embodiments of the invention.

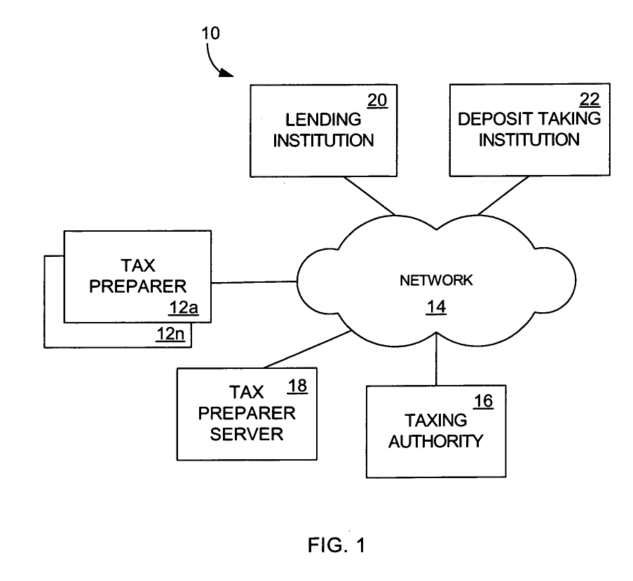

Referring now to FIG. 1, a system 10 for administering a dual account loan system pursuant to some embodiments is shown. In the embodiment depicted in FIG. 1, a number of tax preparer devices 12a-n are shown in communication with one or more tax preparer servers 18, lending institutions 20, deposit taking institutions 22 and taxing authorities 16 via a communication network 14.

Each of the entities or devices may include one or more computing devices capable of performing the various functions described herein. For example, each tax preparer device 12 may be a computing device located at a tax preparer location and in communication with the other entities depicted in FIG. 1. In some embodiments, one or more tax preparer devices 12 may be networked together and in communication with tax preparer server 18 to centrally control, manage and administer the issuance and processing of loans pursuant to the present invention. In some embodiments, the tax preparer server 18 is a Web server accessible via a network such as the Internet. In some embodiments, each of the devices of FIG. 1 are in direct or indirect communication with other devices of FIG. 1 over a telecommunications network such as the Internet.

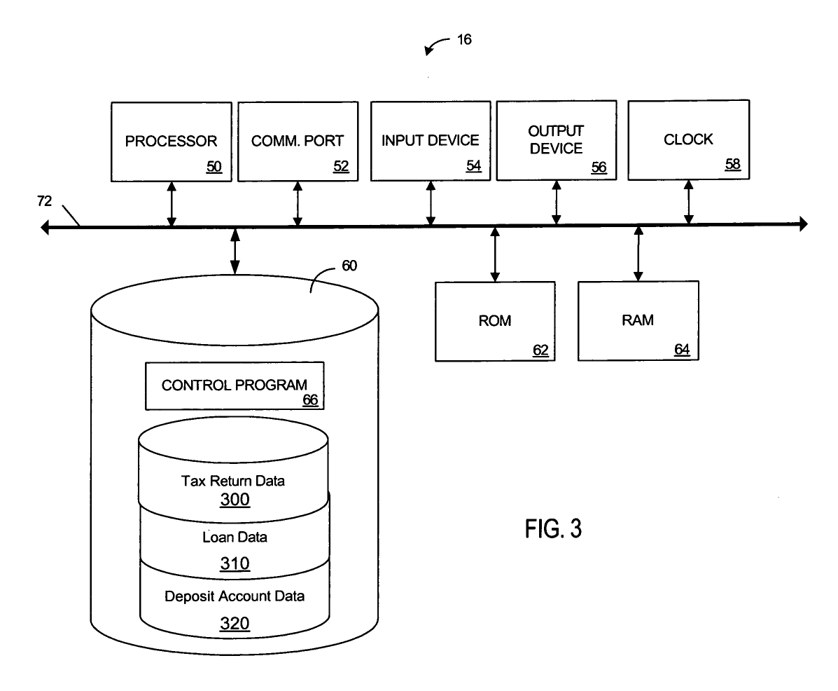

Tax preparer server 18 (one embodiment of which will be described further below in conjunction with FIG. 3) may be operated by or on behalf of a merchant or other entity offering promotions pursuant to embodiments of the present invention. In some embodiments, tax preparer server 18 may be operated by or on behalf of a tax preparation entity (such as, for example, H&R Block®) on behalf of a network of affiliated or owned tax preparer locations.

In other embodiments, tax preparer server 18 may be operated by or on behalf of a financial institution such as lending institution 20 or a deposit taking institution 22. Tax preparer server 18 may be a stand-alone computer configured to administer, manage or support the issuance, settlement and administration of loans issued pursuant to the present invention. In some embodiments, the functionality of tax preparer server 18 may be included in existing devices configured to process transaction data (e.g., as a part of one or more tax preparer devices 12).

Lending institution 20 is a financial institution that issues consumer loans such as RALs or iRALs pursuant to embodiments of the present invention. Deposit taking institution 22 is a financial institution that issues and manages deposit accounts on behalf of taxpayers pursuant to embodiments of the present invention. In some embodiments, lending institution 20 and deposit taking institution 22 may be the same entity or affiliated entities.

As used herein, network 14 may employ any of a number of different types and modes of communication, and may be for example, a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, a cable television network, or an Internet Protocol (IP) network such as the Internet, an intranet or an extranet. Network 14 may also be a network of different networks including, for example, the Internet, financial transaction networks (such as the VisaNet®) network), or other similar networks configured to route and transmit payment information. A variety of individual networks and network protocols may be used in combination to transmit information between devices. Moreover, as used herein, communications include those enabled by wired or wireless technology.

As will be described further below, system 10 is operated to allow the issuance and administration of RAL loans in an efficient manner and to allow the loan proceeds to be repaid reliably, accurately and efficiently. Among other benefits that will be apparent to those skilled in the art, consumers will benefit from ease of use and an ability to efficiently pay off loans and tax preparers and lending institutions will benefit from ease of administration and greater assurance of being repaid in a timely manner.

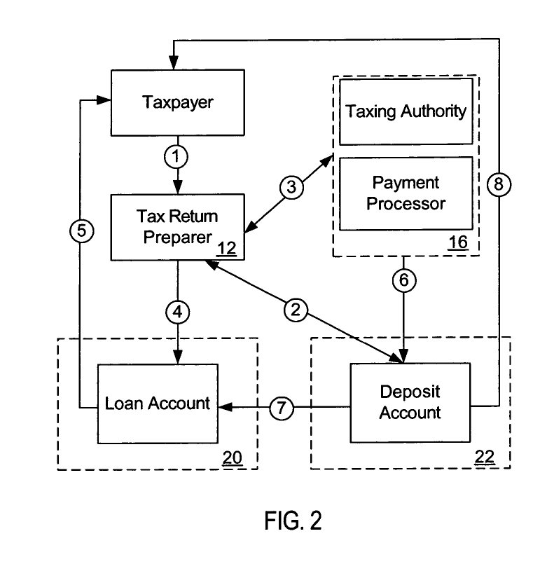

Further details of one embodiment of tax preparer server 18 will now be described by referring to FIG. 2. In one embodiment, tax preparer server 18 is operated by a merchant processor which has a relationship with a merchant desiring to offer promotions pursuant to embodiments of the present invention. Those skilled in the art will recognize, upon reading this disclosure, that tax preparer server 18 may be implemented as a system controller, a dedicated hardware circuit, an appropriately programmed general purpose computer, or any other equivalent electronic, mechanical or electro-mechanical device capable of providing the functionality described herein.

FIG. 2 is a block diagram illustrating a loan administration transaction flow pursuant to some embodiments of the present invention. In the block diagram of FIG. 2, the tax preparer server 18 is not shown; instead, it is assumed that certain messages transmitted to and from the tax return preparer device 12 are transmitted to (and from) the tax preparer server 18. In some embodiments, some or all of the functions of the tax preparer server 18 are performed by tax return preparer device 12.

The administration and processing of loans pursuant to embodiments of the present invention generally proceeds as described below (with reference numbers 12, 16, 20 and 22 referring to entities and devices, and reference numbers (1)-(8) referring to communications between devices). For purposes of illustrating features of some embodiments, an example RAL (or iRAL) transaction will be described in which a taxpayer is entitled to a refund of $2,000, and the tax preparer assesses a RAL fee of $65.

As a first communication (1), the taxpayer interacts with a tax preparation location and provides tax return information to a tax return preparer 12. The tax return preparer 12 completes the tax return and determines that the taxpayer is entitled to a $2,000 refund. Because the taxpayer is entitled to a refund, the taxpayer is given an opportunity to receive access to the funds within two to three days by applying for a RAL secured by the refund (if an iRAL is desired, the taxpayer may receive an iRAL amount immediately). If a RAL is desired, the taxpayer completes a RAL application (either on paper or electronically). The RAL application data is submitted to tax return preparer device 12.

As a second communication (2) the tax return preparer 12 selects an available deposit account number (provided to them by the deposit taking institution 22) and designates the selected deposit account number as the account into which the taxing authority 16 is authorized to deposit the taxpayer's tax refund amount. In some embodiments, the taxing authority 16 is authorized to deposit the tax refund amount using the Automated Clearing House (ACH) system, and an ACH credit authorization form is executed by the taxpayer.

The taxpayer's information is provided to the deposit taking institution 22 to cause the deposit taking institution to open the deposit account. The deposit account information is provided to the taxpayer and one or more access instruments (such as an ATM or debit card) are provided or mailed to the customer. The deposit account is an account that may receive other deposits by the taxpayer (e.g., via an ACH credit, a wire transfer, a direct deposit or an ATM deposit). Further, the deposit account may be an interest bearing or savings account. In some embodiments, the taxpayer may designate an existing deposit account for use as the account into which the tax refund amount will be deposited.

As a third communication (3), the tax return preparer 12 completes the taxpayer's tax return (including information identifying the deposit account into which the tax refund is to be electronically deposited) and submits it to the taxing authority 16 for processing. The taxing authority 16 performs initial processing to determine if the taxpayer does appear to qualify for a refund and sends a “debt indicator” to the tax return preparer 12. In some embodiments, such as where the taxpayer desires an iRAL rather than a RAL, this communication may be performed after disbursement of the iRAL proceeds.

As a fourth communication (4), the tax return preparer 12 transmits the taxpayer's RAL application to the lending institution 20 where a decision is made whether to grant the RAL request. If the lending institution 20 approves the request, a loan account is established for the taxpayer at the lending institution 20. The underwriting performed by the lending institution 20 may follow, for example, the institution's standard underwriting procedures for approving short term secured loans such as RALs.

As a fifth communication (5), the lending institution 20 causes the loan proceeds to be disbursed. In the case of an iRAL, some or all of the loan proceeds are disbursed prior to receipt of the debt indicator. For RALs, the loan proceeds will be disbursed after receipt of the debt indicator. In some embodiments, the loan proceeds (less the commission charged by and paid to the tax return preparer 12) are disbursed directly to the taxpayer from the lending institution 20 (e.g., via a check payable to the taxpayer or a stored value card issued on behalf of the lending institution 20). The taxpayer instructs the deposit taking institution 22 to remit the refund proceeds to the lending institution 20. For example, the tax return preparer 12 may obtain the taxpayer's authorization or assignment of the refund proceeds from the deposit taking institution 22 to the lending institution 20.

As a sixth communication (6), after the taxing authority processes the taxpayer's tax return, instructions are provided by the taxing authority to a payment processor (such as, in the case where the taxing authority is the U.S. Internal Revenue Service, the instructions are provided to the U.S. Financial Management Service) authorizing payment of the refund amount to the taxpayer. In accordance with the ACH credit instructions provided by the taxpayer at communication (2), the refund amount is transferred via an electronic funds transfer to the deposit account of the taxpayer at the deposit taking institution 22. In the illustrative example, $2,000 is transferred into the deposit account at the deposit taking institution 22.

As a seventh communication (7), upon notification that a deposit (such as an ACH credit) from the payment processor associated with the taxing authority 16 (such as a credit from the Financial Management Service) has been received for a deposit account that is associated with a RAL, the deposit taking institution 22 will sweep the funds from the deposit account to the lending institution 20 and cause the taxpayer's loan amount to be repaid. In some embodiments, this sweep function will ensure that taxpayers are able to continue to access funds in their deposit account without having access to RAL-burdened funds.

In some embodiments, the sweep function may be implemented as follows. When an ACH arrives at the deposit taking institution 22, the credit will be memo-posted into the taxpayer's deposit account. At the same time, a debit is memo-posted to the deposit account for the same amount of credit (this has the effect of holding funds for the day). During nightly processing, an ACH transaction is created to pay off the taxpayer's corresponding loan amount at the lending institution 20. If the amount of the ACH received from the taxing authority 16 is greater than the amount swept into the loan account, the additional funds will be available in the taxpayer's deposit account the next day. Both the memo-posted transactions are removed from the taxpayer's deposit account.

In this manner, even if the balance of the taxpayer's deposit account is reduced to zero, the deposit account remains open for continued use by the taxpayer and/or to receive a tax deposit based on future tax returns processed through the system. That is, the taxpayer may continue to use the deposit account by depositing additional funds into the account. The deposit account may eventually be closed (e.g., after a period of inactivity). The lending institution 20 may (or may not) choose to close the taxpayer's loan account after the loan amount is repaid.

As an eighth communication (8), if the refund amount deposited into the taxpayer's deposit account exceeds the loan obligation, the taxpayer has access to the funds in any of a number of ways. For example, the taxpayer may withdraw the funds using a check, a debit card, or the like. As discussed above, even if the balance of the deposit account is reduced to zero, the account remains open and available for use by the taxpayer. In this manner, the deposit taking institution 22 may establish a banking relationship with new customers (many of whom may have previously been “unbanked”). Taxpayers benefit as they have the opportunity to establish a banking relationship and earn interest on deposits in the deposit account.

As discussed above, taxpayers may also be given the opportunity to receive a RAC (or a direct deposit of their refund). The process is similar to the RAL process described above, except no loan account is established. A deposit account is established for the taxpayer at the deposit taking institution and the RAC is deposited into the account. The taxpayer may elect to receive the funds in any of a number of different manners (via a check, via a stored value card, etc.). In any event, the deposit account remains open for the taxpayer's continued use. In some situations, a loan account may need to be opened for the taxpayer after the taxing authority processes the tax return. An example may be a situation where the taxpayer expects to receive a $2000 RAC (less fees), but the IRS finds errors in the return such that the taxpayer will not receive any refund. In this situation, the taxpayer may owe the tax return preparer fees (for tax return preparation) and a loan account is established to pay the tax return preparer the fees.

FIG. 3 is a block diagram of the internal architecture of tax preparer server 18 according to one embodiment of the invention. As illustrated, tax preparer server 18 includes a microprocessor 50 in communication with communication bus 72. Microprocessor 50 may be a Pentium™ or other type of processor and is used to execute processor-executable process steps to control the components of tax preparer server 18 to provide functionality according to embodiments of the present invention.

A communication port 52 is also in communication with communication bus 72. Communication port 52 is used to transmit data to and to receive data from devices external to tax preparer server 18. Communication port 16 is therefore preferably configured with hardware suitable to physically interface with desired external devices and/or network connections. In one embodiment, files of electronic information are transmitted to and received from tax preparer server 18, lending institution 20, deposit taking institution 22, taxing authority 16 and other devices via communication port 52.

An input device 54 and an output device 56 are also in communication with communication bus 72. Any known input device may be used as input device 54, including a keyboard, mouse, touch pad, voice-recognition system, or any combination of these devices. Input device 54 may be used by an entity to input tax return and loan application information and other data to tax preparer server 18. Such information may also be input to tax preparer server 18 via communication port 52. Commands for controlling operation of tax preparer server 18 may also be input using input device 54, such as commands to transmit a file, to receive a file, or the like.

Output device may be any of a number of known output devices, such as, for example, a display device, a printer, or the like. A variety of memory devices may also be coupled to communication bus 72, including a random-access memory (RAM) 64 to provide microprocessor 50 with fast data storage and retrieval. In this regard, processor-executable process steps being executed by microprocessor 50 are typically stored temporarily in RAM 64 and executed therefrom by microprocessor 50. A read-only memory (ROM) 62, in contrast, provides storage from which data can be retrieved but to which data cannot be stored. Accordingly, ROM 62 may be used to store invariant process steps and other data, such as basic input/output instructions and data used during system boot-up or to control communication port 52. One or both of RAM 64 and ROM 62 may communicate directly with microprocessor 50 instead of over communication bus 72.

A data storage device 60 stores, among other data, a control program 66 of processor-executable process steps. Microprocessor 50 executes process steps of control program 66 to control tax preparer server 18 to issue and administer RALs pursuant to embodiments of the present invention. More specifically, the process steps of control program 66 may be executed by microprocessor 50 to achieve the functionality described in conjunction with FIGS. 2 and 3. Microprocessor 50 and data storage device 60 may each be, for example: (i) located entirely within a single computer or other computing device; or (ii) connected to each other by a remote communication medium, such as a serial port cable, telephone line or radio frequency transceiver. In one embodiment, tax preparer server 18 may comprise one or more computers that are connected to a remote server computer for maintaining databases.

The process steps of control program 66 may be read from a computer-readable medium (e.g., a floppy disk, a magnetic tape, a signal encoding the process steps, or the like) and then stored in data storage device 60 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

Data storage device 60, in one embodiment, may also store (or have access to) a tax return database 300, a loan database 310 and a deposit account database 320. For example, tax return database 300 may store data about tax returns processed by tax preparers 12. Loan database 310 may store data about loans issued to taxpayers through tax preparers 12, and deposit account database 320 may store data associated with deposit accounts associated with taxpayers and loans.

As will be understood by those skilled in the art, the schematic illustrations and accompanying descriptions of the databases presented herein are exemplary arrangements for stored representations of information. A number of other arrangements may be employed besides those suggested by the tables shown. Similarly, the illustrated entries of the databases represent exemplary information only; those skilled in the art will understand that the number and content of the entries can be different from those illustrated herein.

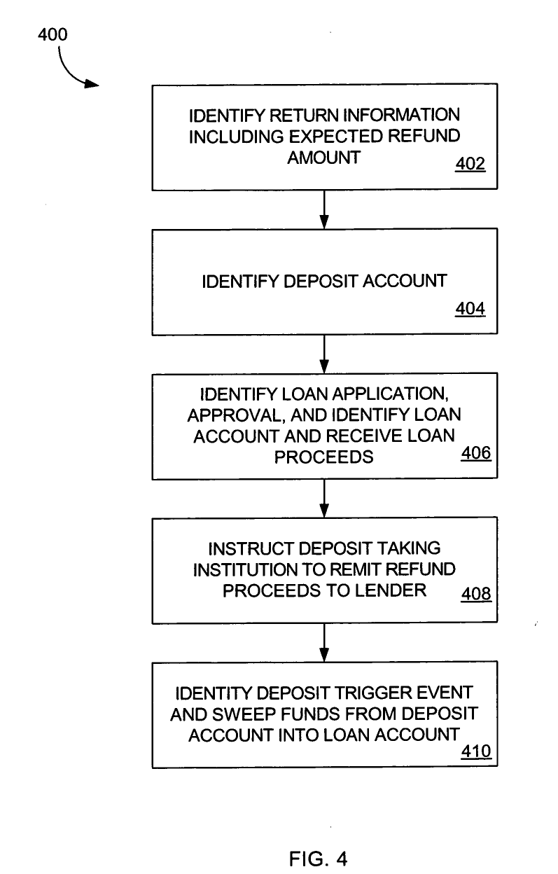

Reference is now made to FIG. 4, where a flow chart is shown which represents an exemplary process 400 for administering a dual account loan pursuant to some embodiments of the present invention. The particular arrangement of elements in the flow chart of FIG. 4 is not meant to imply a fixed order to the steps; embodiments of the present invention can be practiced in any order that is practicable. In one embodiment, some or all of the steps of process 400 are performed under the direction or control of tax preparer server 18. In other embodiments, some or all of the steps may be performed by other devices or groups of devices of system 10.

Process 400 starts at 402 where a tax preparer identifies return information including an expected refund amount. For example, this may be performed by a tax preparer operating a tax preparer device 12 in communication with a tax preparer server 18 after a taxpayer has provided tax return information. The return information may be collected and analyzed using standard return processing software (such as the software used by tax preparers associated with H&R Block®).

Processing continues at 404 where a deposit account is identified. The deposit account may be a new account established at a deposit taking institution 22 or it may be an existing account currently held by the taxpayer. The identification includes the identification of the institution routing number and the account number. Processing at 404 may include obtaining the taxpayer's authorization to credit the account with the tax refund amount.

Processing continues at 406 where a loan application is identified and, if approved, a loan account is identified and loan proceeds are received for disbursement to the taxpayer. Processing at 406 may include obtaining a written or electronic loan application executed by the taxpayer. This information is transmitted to on or more lending institutions for decisioning. If the application is approved, a loan account is established and loan proceeds are disbursed to the taxpayer. In some embodiments, the loan proceeds are disbursed immediately to the taxpayer. In some embodiments, the loan proceeds are disbursed after several business days (e.g., after a “debt indicator” is received from the taxing authority).

Processing continues at 408 where the deposit taking institution 22 is instructed to remit refund proceeds to the lending institution 20 after receipt of the tax refund. For example, as discussed above, this may involve setting up a watch for a trigger event to sweep some or all of the refund amount to the lending institution as soon as the refund amount is deposited into the taxpayer's deposit account.

Processing continues at 410 where the deposit trigger event is identified and funds are swept from the deposit account into the corresponding loan account at the lending institution 20. For example, daily deposits received from the taxing authority may be monitored to identify those deposits associated with loans pursuant to the present invention. Once such a deposit (the “trigger event”) is identified, proceeds may be swept into the corresponding loan account at the lending institution 20 to pay off the taxpayer's loan. In this manner, embodiments ensure the accurate, efficient and prompt disbursement of RAL proceeds to taxpayers as well as the accurate, efficient and prompt repayment of the RAL.

Although the present invention has been described with respect to a preferred embodiment thereof, those skilled in the art will note that various substitutions may be made to those embodiments described herein without departing from the spirit and scope of the present invention. For example, although the dual account loan system is described for use with loans secured by tax returns, embodiments may also be provided to administer loans secured by other transaction.

What is claimed is:

1. A method, comprising:
identifying a deposit account to receive an expected refund amount from a taxing authority;
establishing a loan account and disbursing loan proceeds to a taxpayer;
monitoring the deposit account to identify a trigger event; and
transferring funds from the deposit account to the loan account upon occurrence of the trigger event.

2. The method of claim 1, wherein the expected refund amount is identified from tax return information associated with the taxpayer.

3. The method of claim 1, further comprising:
determining that the taxpayer is eligible for an instant refund loan; and
wherein the disbursing loan proceeds further comprises providing the taxpayer with the loan proceeds substantially immediately.

4. The method of claim 1, further comprising:
determining that the taxpayer is at least one of (a) not eligible for and (b) not interested in an instant refund loan; and
wherein the disbursing loan proceeds further comprises providing the taxpayer with the loan proceeds after receipt of a debt indicator from a taxing authority.

5. The method of claim 1, wherein the disbursing loan proceeds comprises providing the taxpayer access to funds from the loan account.

6. The method of claim 5, wherein providing the taxpayer access to funds further comprises providing the taxpayer with at least one of (a) a checkbook, (b) a check, (c) a debit card, (d) a loaded stored value card, and (e) electronic funds transfer access.

7. The method of claim 1, wherein the trigger event is the identification of a particular deposit from the taxing authority.

8. The method of claim 1, wherein the trigger event is the identification of an Automated Clearing House (ACH) deposit into the deposit account from the taxing authority.

9. The method of claim 1, wherein the trigger event is the identification of an Automated Clearing House (ACH) deposit approximately equal to the expected refund amount.

10. The method of claim 7, wherein the transferring funds further comprises:
posting a credit to the deposit account in the amount of the particular deposit; and
posting a debit to the deposit account in the amount equal to the loan proceeds, wherein the posting a credit and posting a debit are performed on the same day.

11. A system, comprising:
means for identifying a deposit account to receive an expected refund amount from a taxing authority;
means for establishing a loan account and disbursing loan proceeds to a taxpayer;
means for monitoring the deposit account to identify a trigger event; and
means for transferring funds from the deposit account to the loan account upon occurrence of the trigger event.

12. The system of claim 11, wherein the expected refund amount is identified from tax return information associated with the taxpayer.

13. The system of claim 11, further comprising:
means for determining that the taxpayer is eligible for an instant refund loan; and
wherein the means for disbursing loan proceeds further comprises means for providing the taxpayer with the loan proceeds substantially immediately.

14. The system of claim 11, further comprising:
means for determining that the taxpayer is at least one of (a) not eligible for and (b) not interested in an instant refund loan; and
wherein the means for disbursing loan proceeds further comprises means for providing the taxpayer with the loan proceeds after receipt of a debt indicator from a taxing authority.

15. The system of claim 11, wherein the means for disbursing loan proceeds comprises means for providing the taxpayer access to funds from the loan account.

16. The system of claim 15, wherein the means for providing the taxpayer access to funds further comprises means for providing the taxpayer with at least one of (a) a checkbook, (b) a check, (c) a debit card, (d) a loaded stored value card, and (e) electronic funds transfer access.

17. The system of claim 11, wherein the trigger event is the identification of a particular deposit from the taxing authority.

18. The system of claim 11, wherein the trigger event is the identification of an Automated Clearing House (ACH) deposit into the deposit account from the taxing authority.

19. The system of claim 11, wherein the trigger event is the identification of an Automated Clearing House (ACH) deposit approximately equal to the expected refund amount.

20. The system of claim 17, wherein the means for transferring funds further comprises:
means for posting a credit to the deposit account in the amount of the particular deposit; and
means for posting a debit to the deposit account in the amount equal to the loan proceeds, wherein the posting a credit and posting a debit are performed on the same day.

21. An apparatus, comprising:
a processor;
a communications device in communication with said processor to receive data identifying a loan application and tax refund information; and
a memory unit in communication with said processor and storing a program, wherein the processor is operative with said program to
identify a deposit account to receive an expected refund amount from a taxing authority;
establish a loan account and disbursing loan proceeds to a taxpayer;
monitor the deposit account to identify a trigger event; and
transfer funds from the deposit account to the loan account upon occurrence of the trigger event.
